(19) United States
(12) Patent Application Publication
(10) Pub. No.: US 2018/0328631 A1
(43) Pub. Date: Nov. 15, 2018

(54) THERMAL CONTROL APPARATUS USING THERMAL MODEL AND TEMPERATURE-INFERENCE MECHANISM

(71) Applicants: DELTA ELECTRONICS, INC., Taoyuan City (TW); NATIONAL CHENG KUNG UNIVERSITY, Tainan City (TW)

(72) Inventors: Tsu-Sheng LEE, Tainan City (TW); Chih-Yang CHEN, Taoyuan City (TW); Yu-Lin FANG, Taoyuan City (TW); Chih-Yin LIU, Tainan City (TW); Cheng-Ying HSIEH, Tainan City (TW); Cheng-Hui LI, Tainan City (TW); Jie-Jhong LIANG, Tainan City (TW); Chih-Yen CHEN, Tainan City (TW)

(21) Appl. No.: 15/976,208

(22) Filed: May 10, 2018

(30) Foreign Application Priority Data
May 12, 2017 (CN) 201710334446.1

(51) Int. Cl. F25B 21/02; G05B 13/04

(52) U.S. Cl. CPC F25B 21/02; F25B 2700/2107; F25B 2321/0212; G05B 13/048

(57) ABSTRACT

A thermal control apparatus is provided. The thermal control apparatus includes a controller and a thermoelectric cooling module. The thermoelectric cooling module includes: a thermal sensor for measuring a first current temperature of a first location of the thermoelectric cooling module; and a thermoelectric cooling device for adjusting the first current temperature according to a control signal from the controller. The controller calculates a predicted temperature of a second location of the thermoelectric cooling module according to the measured first current temperature and a thermal model between the first location and the second location. The controller further automatically adjusts a first target temperature of the first location according to the predicted temperature and an expected temperature of the second location, and controls the thermoelectric cooling device to automatically adjust the first current temperature of the first location to reach the first target temperature.

### CROSS REFERENCE TO RELATED APPLICATIONS

This Application claims priority of China Patent Application No. 201710334446.1, filed on May 12, 2017, the entirety of which is incorporated by reference herein.

### BACKGROUND OF THE INVENTION

### Field of the Invention

The present invention relates to thermal control, and, in particular, to a thermal control apparatus and a method thereof using a virtual thermal model and temperature-inference mechanism.

### Description of the Related Art

Polymerase chain reaction (PCR) is one technique of molecular biology for expanding specific segments of deoxyribonucleic acid (DNA). A PCR can be performed outside the organism, and does not rely on organisms such as Escherichia coli (E. coli) or yeast. Microbial replication is a time-consuming and labor-intensive process. First, the DNA is cleaved by a restriction enzyme and added to a plasmid by ligase. Then, the DNA is sent to the E. coli competent cell by electroporation or heat shock, and the E. coli competent cell is propagated in a culture dish. After performing complicated separation and purification processes, it usually takes about a week to make a greater number of copies of the DNA fragments. Compared with microbial replication, it usually takes an hour to perform a PCR process, thereby saving a huge amount of time and operations. PCR technology is widely used in medical and biological laboratories. For example, PCR technology can be used to determine whether a test specimen displays a genetic disease profile, diagnosis of infectious diseases, gene duplication, and paternity testing.

The PCR process is usually performed on specific biological equipment such as PCR equipment. Various cycles of heating and cooling of the polymerase are repeatedly performed in the PCR process, and thus a container (e.g., a test tube) filled with polymerase is placed within a thermal control apparatus for thermal control. For example, the container can be placed on a base of a thermoelectric cooler for heating and cooling control. During the PCR process, a PCR cycle is to heat up the polymerase to a first specific temperature (e.g. 90˜95° C.) and then cool down the polymerase to a second specific temperature (e.g. 40˜60° C.), and the PCR cycle is performed repeatedly many times.

However, the PCR process relies on precise thermal control to achieve DNA replication. Typically, during the PCR process, the temperature of the PCR liquid in the container cannot be measured directly. In addition, the temperature of the PCR liquid may be not synchronous to the base temperature of the thermoelectric cooler. Accordingly, conventional thermal control methods cannot be used for precise thermal control of the PCR-liquid temperature. Thus, manual calibration of the control parameters of each thermal control apparatus is required, and the manual calibration of the control parameters is very time-consuming, resulting in manufacturing troubles on the production line.

Accordingly, there is demand for a thermal control apparatus and a thermal control method thereof using a virtual thermal model and temperature-inference mechanism for precise thermal control to solve the aforementioned problem.

### BRIEF SUMMARY OF THE INVENTION

A detailed description is given in the following embodiments with reference to the accompanying drawings.

In an exemplary embodiment, a thermal control apparatus is provided. The thermal control apparatus includes a controller and a thermoelectric cooling module. The thermoelectric cooling module includes: a thermal sensor arranged for measuring a first current temperature of a first location of the thermoelectric cooling module; and a thermoelectric cooling device arranged for adjusting the first current temperature of the first location according to a control signal from the controller. The controller calculates the predicted temperature of a second location of the thermoelectric cooling module according to the measured first current temperature of the first location and a thermal model between the first location and the second location of the thermoelectric cooling module. The controller further automatically adjusts a first target temperature of the first location according to the predicted temperature and an expected temperature of the second location, and controls the thermoelectric cooling device to automatically adjust the first current temperature of the first location to reach the first target temperature.

In another exemplary embodiment, a thermal control method for use in a thermal control apparatus is provided, wherein the thermal control apparatus comprises a thermoelectric module having a thermal sensor and a thermoelectric cooling device, the method comprising: utilizing the thermal sensor to measure a first current temperature of a first location of the thermoelectric cooling module; adjusting the first current temperature of the first location via the thermoelectric cooling device; calculating a predicted temperature of a second location of the thermoelectric cooling module according to the measured first current temperature of the first location and a thermal model between the first location and the second location of the thermoelectric cooling module; automatically adjusting a first target temperature of the first location according to the predicted temperature and an expected temperature of the second location; and controlling the thermoelectric cooling device to automatically adjust the first current temperature of the first location to reach the first target temperature.

### BRIEF DESCRIPTION OF THE DRAWINGS

The present invention can be more fully understood by reading the subsequent detailed description and examples with references made to the accompanying drawings, wherein:

FIG. 1 is a schematic block diagram of a thermal control apparatus in accordance with an embodiment of the invention;

FIG. 2 is a diagram of a thermal model in accordance with an embodiment of the invention;

FIG. 3 is a flow chart of a target base temperature-inference method in accordance with an embodiment of the invention; and

FIG. 4 is a flow chart of a thermal control method in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

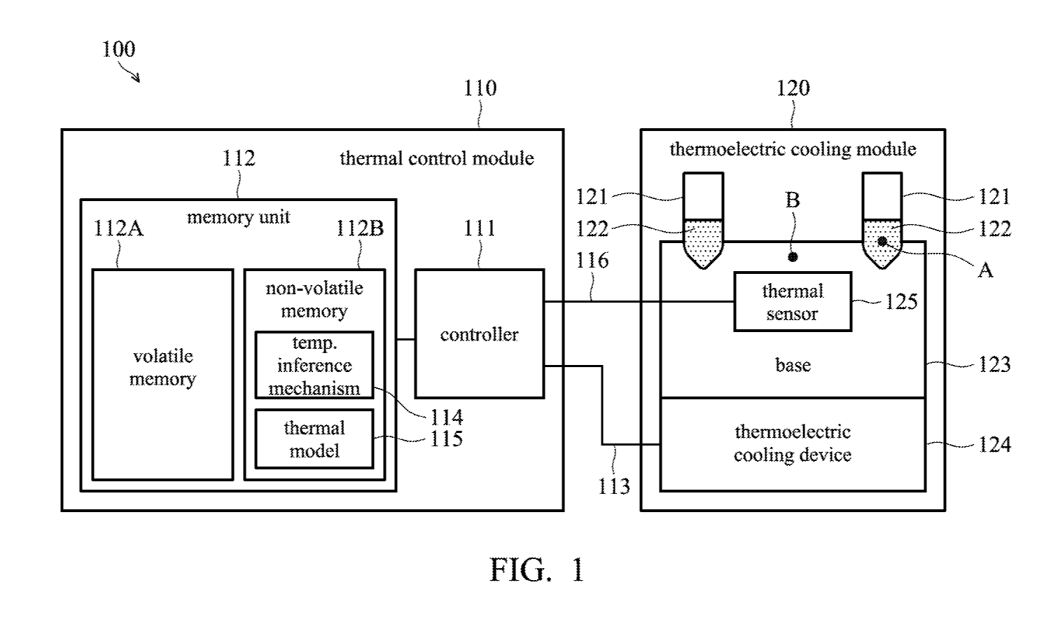

FIG. 1 is a schematic block diagram of a thermal control apparatus in accordance with an embodiment of the invention. As illustrated in FIG. 1, the thermal control apparatus 100 includes a thermal control module 110 and a thermoelectric module 120.

The thermal control module 110 includes a controller 111 and a memory unit 112. In an embodiment, the controller 111 may be a general-purpose processor, a digital signal processor (DSP), or a microcontroller, but the invention is not limited thereto.

The memory unit 112 includes a volatile memory 112A and a non-volatile memory 112B. The volatile memory 112A may be a static random access memory (SRAM) or a dynamic random access memory (DRAM), but the invention is not limited thereto. The non-volatile memory 112B may be a read-only memory (ROM), an electrically-erasable programmable read-only memory (EEPROM), a hard disk, or a solid-state disk, but the invention is not limited thereto.

In an embodiment, the non-volatile memory 112B may store a program or program codes of a temperature-inference mechanism 114 and a thermal model 115, and the details will be described later.

The thermoelectric module 120 may include one or more containers 121, a base 123, a thermoelectric cooling (TEC) device 124, and a thermal sensor 125. The container 121 may be filled with an experimental liquid 122. For example, in the PCR process, the experimental liquid may be a polymerase. In other types of experiments, the experimental liquid may be different types of liquid.

The container 121 may be placed on the base 123, and the base 123 can be regarded as a heating base that is made of materials of high thermal conductivity such as metal, but the invention is not limited thereto. The thermoelectric cooling device 124 may perform heating up or cooling down according to a control signal 113 from the controller 111. For example, the thermoelectric cooling device 124 may be a thermoelectric cooling integrated circuit (IC), or a thermoelectric cooling device implemented by a conventional electric heater and a cooling fan.

The thermal sensor 125 is disposed on the base 123, and is configured to measure a current base temperature of the base 123, and report the measured current base temperature to the controller 111 via a temperature feedback signal 116.

For example, the thermoelectric cooling device 124 may heat up or cool down the experimental liquid 122 in the container 121 via the base 123. Since various heating and cooling cycles (e.g., PCR cycles) should be performed on the experimental liquid 122 (e.g. a polymerase) during the PCR process, and each PCR cycle is to heat up the experimental liquid 122 to a first temperature threshold (e.g. a specific temperature range from 90 to 95° C.), and to cool down the experimental liquid 122 to a second temperature threshold (e.g. a specific temperature range from 40 to 60° C.), wherein the first temperature threshold and the second temperature threshold can be adjusted according to the type and protocals of the experimental liquid 122.

However, during the PCR process, if external equipment is used to measure the temperature of the experimental liquid 122, it will be inconvenient to use. Thus, the temperature of the experimental liquid cannot be measured directly with common PCR equipment. In addition, conventional PCR equipment cannot instantly calculate the current temperature of the experimental liquid according to the measured temperature of the base.

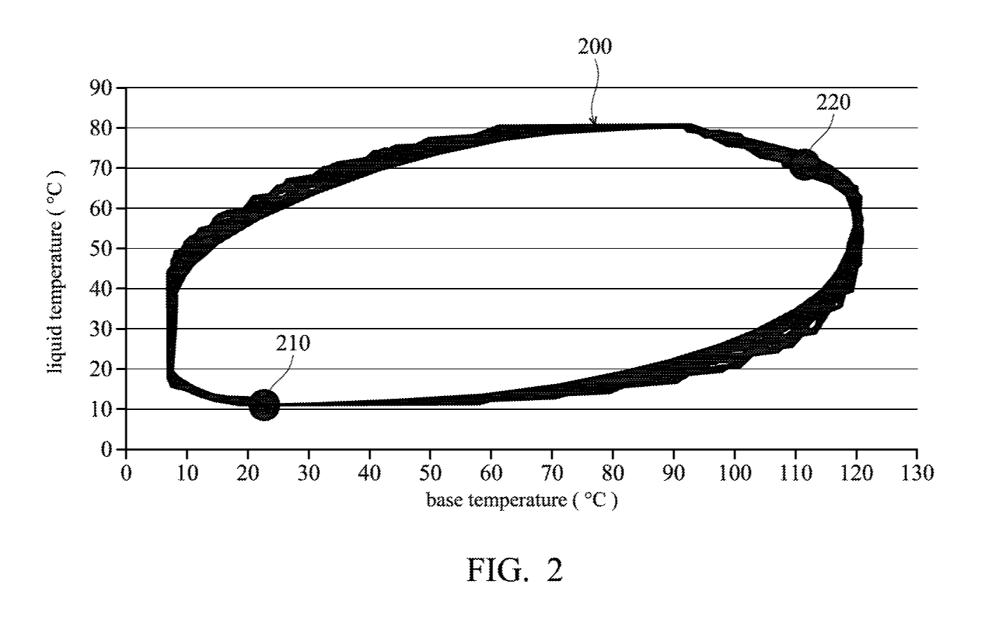

FIG. 2 is a diagram of a thermal model in accordance with an embodiment of the invention. In the invention, a thermal model between the liquid temperature and the base temperature can be built in advance before performing the PCR process. For example, the thermal model between the liquid temperature and the base temperature can be obtained from various experimental statistical results in different environments after mathematical converge analysis. The thermal model records a relationship model between the base temperature and the liquid temperature, and the relationship model can be expressed by the following equation:

Tₗ_{_}_{predicted}(n)=α·Tₗ_{_}_{predicted}(n−1)+β·T_{c}_{_}_{measured}(n−1)+k (1)

where Tₗ_{_}_{predicted}(n) denotes the predicted current liquid temperature; Tₗ_{_}_{predicted}(n−1) denotes the predicted liquid temperature at previous time point; T_{c}_{_}_{measured}(n−1) denotes the measured base temperature at previous time point; α and β are model parameters; k is a thermal model compensation coefficient for compensating for an error wherein the thermal model erroneously determines that the output temperature has reached the target liquid temperature (i.e., there is still an error between the actual liquid temperature and the target liquid temperature).

In some embodiments, the thermal model compensation coefficient k can be calculated for compensating for the predicted liquid temperature. In some embodiments, the thermal model compensation coefficient k can be mathematically integrated into other parameters of the thermal model, and thus the thermal model compensation coefficient k can be omitted. The curve of a thermal model is illustrated in FIG. 2, where the X-axis denotes the base temperature, and the Y-axis denotes the liquid temperature. As shown in FIG. 2, in a single PCR cycle, the liquid temperature will change in response to increment or decrement of the base temperature. For example, starting from point 210 of curve 210 of the thermal model, with increment of the base temperature, the liquid temperature will be moving right along curve 210. After the heating-up process is completed and the cooling-down process has been started, the liquid temperature will be moving left along curve 210 from point 220. It should be noted that curve 200 in FIG. 2 is an example, and it does not indicate that the PCR process must use the thermal model of curve 200.

In a conventional thermal control apparatus, a temperature look-up table can be built in advance using experimental data. However, the conventional thermal control apparatus using the temperature lookup table cannot instantly respond to the slight changes of the base temperature. In addition, the conventional thermal control apparatus cannot respond to errors caused by machine assembly.

In an embodiment, the controller 111 may read the application of the temperature-inference mechanism and the thermal model stored in the non-volatile memory 112B to the volatile memory 112A, and execute the temperature-inference mechanism (e.g., a fuzzy logic algorithm, or other types of inference algorithms), wherein the temperature-inference mechanism may calculate a target base temperature according to a thermal model and one or more expected liquid temperatures. The controller 111 may perform thermal control (e.g., heating or cooling) of the thermoelectric cooling device 124 of the thermoelectric cooling module 120 according to the calculated target base temperature, so that the liquid temperature of the experimental liquid filled in the container 121 of the thermoelectric cooling module 120 can reach the expected liquid temperature.

For example, the temperature-inference mechanism executed by the controller 111 may have inputs from the predicted liquid temperature output from the thermal model and an expected liquid temperature, thereby generating a target base temperature. The controller 111 may update a reference target base temperature table using the target base temperature.

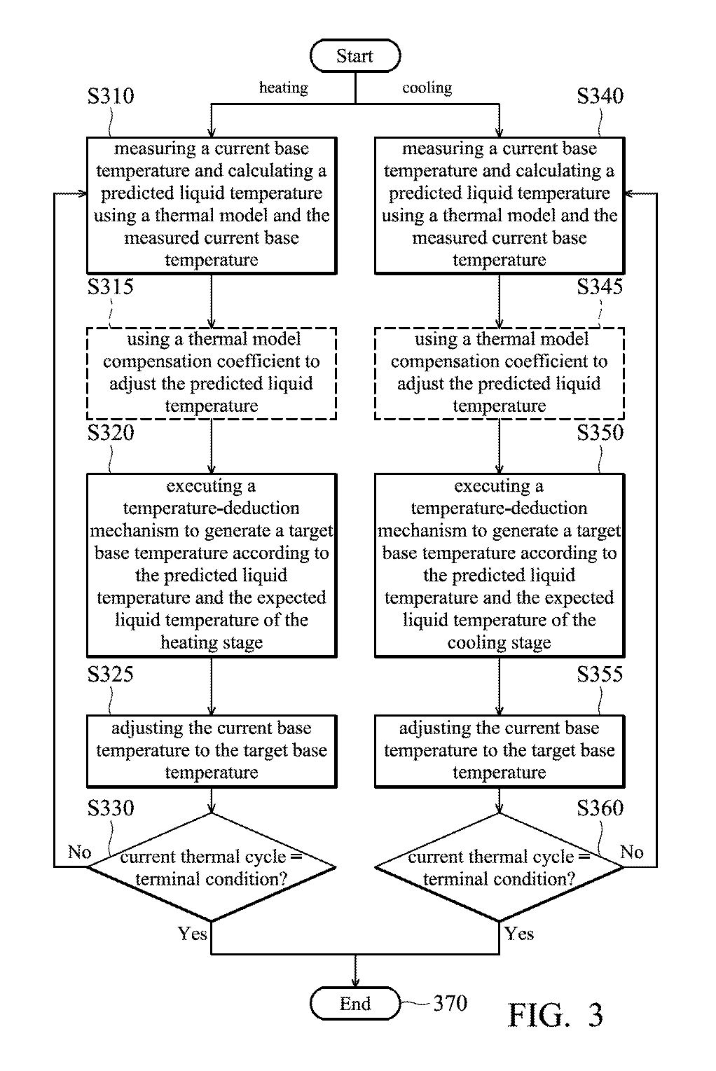

FIG. 3 is a flow chart of a target base temperature-inference method in accordance with an embodiment of the invention. As shown in FIG. 3, the heating process and the cooling process can be separated in a single PCR cycle. For example, during the heating process of the PCR cycle, the expected liquid temperature of heating stage can be set to a first temperature threshold such as a specific temperature or a specific temperature range between 9095° C., and the predicted liquid temperature should be kept for a predetermined time after being heated up to the first temperature threshold. During the cooling process of the PCR cycle, the expected liquid temperature of cooling stage can be set to a second temperature threshold such as a specific temperature or a specific temperature range between 4060 t, and the predicted liquid temperature should be kept for a predetermined time after being cooled down to the second temperature threshold.

For example, in the left half portion in FIG. 3, it indicates the heating process of the thermal control cycle (e.g., a PCR cycle). In step S310, a current base temperature is measured, and a predicted liquid temperature is calculated using a thermal model and the measured current base temperature. For example, the predicted liquid temperature may be 96.4° C.

In step S315, a thermal model compensation coefficient is used to adjust the predicted liquid temperature. The thermal model compensation coefficient may be the thermal model compensation coefficient k in the aforementioned embodiment. In some embodiments, the thermal model compensation coefficient k can be mathematically integrated into other parameters of the thermal model. In this situation, step S315 and the thermal model compensation coefficient k can be omitted.

In step S320, a temperature-inference mechanism is executed to generate a target base temperature according to the predicted liquid temperature and an expected liquid temperature of heating stage. For example, the temperature-inference mechanism may directly generate the target base temperature or alternatively generate a target base temperature offset according to the predicted liquid temperature and the expected liquid temperature of heating stage, where the target base temperature offset is the difference between the target base temperature and the measured current base temperature. If the target base temperature offset is a positive value, it indicates that the current base temperature should be heated up to the target base temperature. If the target base temperature offset is a negative value, it indicates that the current base temperature should be cooled down to the target base temperature.

In step S325, the current base temperature is adjusted to the target base temperature.

For example, when the expected liquid temperature of heating stage is higher than the predicted liquid temperature, it indicates that the current base temperature should be raised to heat up the experimental liquid 122. Thus, the target base temperature offset may be a positive value, and the measured current base temperature is added by the target base temperature offset to obtain the target base temperature. When the expected liquid temperature of heating stage is lower than the predicted liquid temperature, it indicates that the current base temperature should be decreased to cool down the experimental liquid 122. Thus, the target base temperature offset may be a negative value, and the measured current base temperature is added by the target base temperature offset to obtain the target base temperature. Alternatively, the target base temperature can be directly calculated and is used for subsequent calibration.

In step S330, it is determined whether the current thermal control cycle is a terminal condition. If so, the thermal control process is ended (step S370). Otherwise, step S310 is performed, and the next thermal control cycle is repeated. It should be noted that, the terminal condition may indicate a predetermined value, and is for modeling the process rather than for a general PCR process. Various PCR cycles should be repeatedly performed in the PCR process, and the predetermined value is the number of PCR cycles to be repeated in the PCR process. For example, if the predicted liquid temperature has reached target liquid temperature 16 times, the thermal control will end after the 16th thermal control cycle has completed.

The procedure of steps S310˜S330 is to describe the temperature-inference procedure of the target base temperature in the heating process of the thermal control cycle. The right half portion in FIG. 3 is to describe the temperature-inference procedure of the target base temperature in the cooling process of the thermal control cycle. The procedure of steps S340˜360 are similar to that of steps S310˜S330.

In step S340, a current base temperature is measured, and a predicted liquid temperature is calculated using a thermal model and the measured current base temperature. For example, the predicted liquid temperature may be 60.4° C.

In step S345, a thermal model compensation coefficient is used to adjust the predicted liquid temperature. The thermal model compensation coefficient may be the thermal model compensation coefficient k in the aforementioned embodiment. In some embodiments, the thermal model compensation coefficient k can be mathematically integrated into other parameters of the thermal model. In this situation, step S345 and the thermal model compensation coefficient k can be omitted.

In step S350, a temperature-inference mechanism is executed to generate a target base temperature according to the predicted liquid temperature and an expected liquid temperature of cooling stage. For example, the temperature-inference mechanism may directly generate the target base temperature or alternatively generate a target base temperature offset according to the predicted liquid temperature and the expected liquid temperature of cooling stage, where the target base temperature offset is the difference between the target base temperature and the measured current base temperature. If the target base temperature offset is a positive value, it indicates that the current base temperature should be heated up to the target base temperature. If the target base temperature offset is a negative value, it indicates that the current base temperature should be cooled down to the target base temperature. It should be noted that, the expected liquid temperature of cooling stage in step S350 is different from the expected liquid temperature of heating stage in step S320.

In step S355, the current base temperature is adjusted to the target base temperature.

For example, when the expected liquid temperature of cooling stage is higher than the predicted liquid temperature, it indicates that the current base temperature should be raised to heat up the experimental liquid 122. Thus, the target base temperature offset may be a positive value, and the measured current base temperature is added by the target base temperature offset to obtain the target base temperature. When the expected liquid temperature of cooling stage is lower than the predicted liquid temperature, it indicates that the current base temperature should be decreased to cool down the experimental liquid 122. Thus, the target base temperature offset may be a negative value, and the measured current base temperature is added by the target base temperature offset to obtain the target base temperature.

In step S360, it is determined whether the current thermal control cycle is a terminal condition. If so, the thermal control process is ended (step S370). Otherwise, step S310 is performed, and the next thermal control cycle is repeated. It should be noted that the terminal condition may indicate a predetermined value. Various PCR cycles should be repeatedly performed in the PCR process, and the predetermined value is the number of PCR cycles to be repeated in the PCR process. For example, if the predicted liquid temperature has reached target liquid temperature 16 times, the thermal control will end after the 16th thermal control cycle has completed.

In some embodiments, the steps S340˜S360 in FIG. 3 can be omitted, indicating that the upper half thermal control cycle may control the temperature of the experimental liquid.

It should be noted that the temperature-inference method in the invention is not limited to the PCR process. The temperature-inference method can be used in a scenario of performing the thermal control cycles repeatedly using a virtual thermal model and the temperature-inference mechanism to accurately control the temperature of an object under test (e.g., a specific experimental liquid), and can also be used in scenarios where the temperature of the object under test cannot be measured directly using thermal sensors.

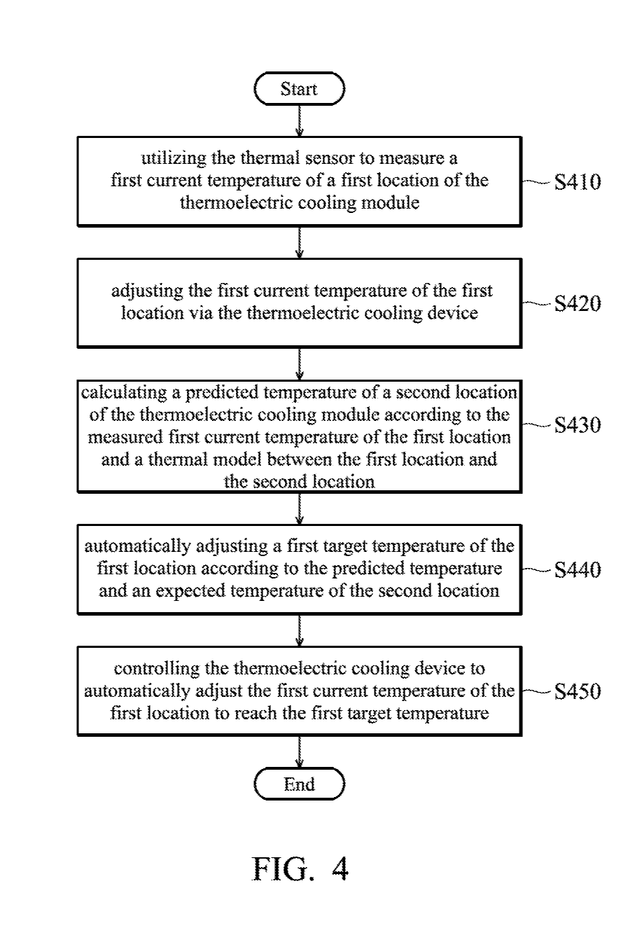

FIG. 4 is a flow chart of a thermal control method in accordance with an embodiment of the invention. It should be noted that the temperature-inference method in FIG. 3 is not limited to the PCR process, and can be widely used in thermal control of two different locations in the thermal control apparatus. Attention is now directed to FIG. 1 and FIG. 4.

In step S410, a thermal sensor 125 is used to measure a first current temperature of a first location of the thermoelectric cooling module 120. For example, the first location may be the location of point B in FIG. 1.

In step S420, the thermoelectric cooling device 124 is used to adjust the first current temperature of the first location.

In step S430, a predicted temperature of a second location of the thermoelectric cooling module 120 is calculated according to a thermal model and the measured first current temperature of the first location. For example, the second location may be the location of point A in FIG. 1, and the thermal model may a temperature-relationship model between the first location and the second location.

In step S440, a first target temperature of the first location is automatically adjusted according to the calculated predicted temperature and an expected temperature of the second location.

In step S450, the thermoelectric cooling device 124 is controlled to automatically adjust the first current temperature of the first location to reach the first target temperature.

For example, as shown in FIG. 1, point A is the location of the object under test (e.g. a second location), and the current temperature of the object under test at point A cannot be measured directly using the thermal sensor. The thermal sensor 125 is disposed at the location of point B (e.g. a first location), and is capable of directly measuring the current temperature of the base 123, and thus the controller 111 may obtain the measured current temperature at the location of point B. Then, the controller 111 may execute the temperature-inference method in the invention that use a temperature-inference mechanism and a thermal model between the first location and the second location to repeatedly perform thermal control cycles to control the current temperature of the object under test, that cannot be measure directly by a thermal sensor, at the location of point A.

In view of the above, a thermal control apparatus and method thereof are provided in the invention. The thermal control apparatus and the thermal control method are capable of precisely controlling the temperature of an object under test (e.g., a specific experimental liquid such as a polymerase) by repeatedly performing thermal control cycles using the thermal model and the temperature-inference mechanism. In addition, the thermal control apparatus and method can be used in scenarios where the temperature of the object under test cannot be measured directly using thermal sensors.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A thermal control apparatus, comprising:
a controller; and
a thermoelectric cooling module, comprising:
a thermal sensor, arranged for measuring a first current temperature of a first location of the thermoelectric cooling module; and
a thermoelectric cooling device, arranged for adjusting the first current temperature of the first location according to a control signal from the controller,
wherein the controller calculates a predicted temperature of a second location of the thermoelectric cooling module according to the measured first current temperature of the first location and a thermal model between the first location and the second location of the thermoelectric cooling module,
wherein the controller further automatically adjusts a first target temperature of the first location according to the predicted temperature and an expected temperature of the second location, and controls the thermoelectric cooling device to automatically adjust the first current temperature of the first location to reach the first target temperature.

2. The thermal control apparatus as claimed in claim 1, wherein the thermoelectric cooling module further comprises a container and a base, and the container is arranged to fill with experimental liquid at the second position, and the thermoelectric cooling device performs thermal control on the experimental liquid in the container via the base.

3. The thermal control apparatus as claimed in claim 2, wherein the experimental liquid is a polymerase.

4. The thermal control apparatus as claimed in claim 1, wherein the controller executes a temperature-inference mechanism for calculating the predicted temperature of the second location of the thermoelectric cooling module according to the measured first current temperature of the first location and the thermal model.

5. The thermal control apparatus as claimed in claim 4, wherein the temperature-inference mechanism is a fuzzy logic algorithm.

6. A thermal control method for use in a thermal control apparatus, wherein the thermal control apparatus comprises a thermoelectric module having a thermal sensor and a thermoelectric cooling device, the method comprising:
utilizing the thermal sensor to measure a first current temperature of a first location of the thermoelectric cooling module;
adjusting the first current temperature of the first location via the thermoelectric cooling device;
calculating a predicted temperature of a second location of the thermoelectric cooling module according to the measured first current temperature of the first location and a thermal model between the first location and the second location of the thermoelectric cooling module;
automatically adjusting a first target temperature of the first location according to the predicted temperature and an expected temperature of the second location; and
controlling the thermoelectric cooling device to automatically adjust the first current temperature of the first location to reach the first target temperature.

7. The thermal control method as claimed in claim 6, wherein the thermoelectric cooling module further comprises a container and a base, and the container is arranged to fill experimental liquid at the second position, and the thermoelectric cooling device performs thermal control on the experimental liquid in the container via the base.

8. The thermal control method as claimed in claim 7, wherein the experimental liquid is a polymerase.

9. The thermal control method as claimed in claim 6, further comprising:
executing a temperature-inference mechanism for calculating the predicted temperature of the second location of the thermoelectric cooling module according to the measured first current temperature of the first location and the thermal model.

10. The thermal control method as claimed in claim 9, wherein the temperature-inference mechanism is a fuzzy logic algorithm.
